(19) United States
(12) Patent Application Publication
(10) Pub. No.: US 2014/0140660 A1
(43) Pub. Date: May 22, 2014

(54) POLARITY SCHEME FOR PARALLEL-OPTICS DATA TRANSMISSION

(71) Applicants: Scott Eaker Buff, Hickory, NC (US); Terry Lee Cooke, Hickory, NC (US); Robert Ashley Herring, Hickory, NC (US); Brian Keith Rhoney, Hickory, NC (US); Wesley Allan Yates, Lenoir, NC (US)

(72) Inventors: Scott Eaker Buff, Hickory, NC (US); Terry Lee Cooke, Hickory, NC (US); Robert Ashley Herring, Hickory, NC (US); Brian Keith Rhoney, Hickory, NC (US); Wesley Allan Yates, Lenoir, NC (US)

(21) Appl. No.: 13/751,232

(22) Filed: Jan. 28, 2013

Related U.S. Application Data
(60) Provisional application No. 61/727,869, filed on Nov. 19, 2012.

(51) Int. Cl. G02B 6/38

(52) U.S. Cl. CPC G02B 6/381
USPC 385/59; 385/78

(57) ABSTRACT

A fiber optic assembly includes first and second sets of ferrules. The first set of ferrules includes a first ferrule supporting a first plurality of optical fibers including first and second groups of optical fibers, a second ferrule supporting a second plurality of optical fibers including third and fourth groups of optical fibers, and a third ferrule supporting a third plurality of optical fibers including fifth and sixth groups of optical fibers. The second set of ferrules includes a fourth ferrule and a fifth ferrule. The fourth ferrule supports optical fibers of the first, second, third, and fourth groups of optical fibers, and the fifth ferrule supports optical fibers of the third, fourth, fifth, and sixth groups of optical fibers.

### CROSS-REFERENCE

This application claims the benefit of U.S. Provisional Application No. 61/727,869, filed Nov. 19, 2012, which is incorporated by reference herein in its entirety.

### BACKGROUND

Aspects of the present disclosure relate generally to parallel-optics data transmission and schemes for connecting optical fibers within a module and/or harness cable assembly.

Harness assemblies, including harness cables and modules, may be used to arrange optical fibers according to various schemes or mappings to facilitate data transmission via parallel optics. Because a single signal may be broken down and parsed into separate optical fibers for communication in parallel with one another, accuracy in the routing of the optical fibers and transmission of the signal components allows for faster communications.

A fiber optic assembly, in the form of a harness cable or a module, may be used on opposite ends of trunk cables for reconfiguring optical pathways on either end of the trunk cables for transmission via the trunk cables. Typically the fiber optic assemblies are labeled or otherwise differentiated from one another, such as an “A” assembly and a “B” assembly, to indicate how the optical fibers should be connected to the assemblies on either end of the trunk cables. As such, an operator configuring a system configured for parallel optics data communication must follow the “A” assembly routing scheme for one side of the trunk cables, and follow the “B” assembly routing scheme for the other side of the trunk cables.

However, in large data centers, orientations of large numbers of trunk cables routed together may be difficult to identify, and ends of the trunk cables may be large distances apart (e.g., on the order of a kilometer or more). As such attachment of the cable assemblies may become cumbersome and error prone due to the differences between “A” and “B” assemblies. Furthermore, from a manufacturing/supplier perspective, having a single part design and labeling scheme for both “A” and “B” assemblies, allows for improved manufacturing and inventory efficiencies. A need exists for an improved fiber-routing or polarity scheme and corresponding cable assembly for connecting optical fibers for parallel-optics data transmission to allow an operator to attach optical fibers to identical pairs of the cable assembly in the same port numbers, regardless of on which side of the trunk cables the particular cable assembly is located.

### SUMMARY

One embodiment relates to a fiber optic assembly, such as a conversion module or harness cable assembly, that includes a first set of ferrules and a second set of ferrules, as may be associated with a fiber optic connector, port, or adapter. The first set of ferrules includes a first ferrule supporting a first plurality of optical fibers, second ferrule supporting a second plurality of optical fibers, and a third ferrule supporting a third plurality of optical fibers. The first plurality of optical fibers includes first and second groups of optical fibers, the second plurality of optical fibers includes third and fourth groups of optical fibers, and the third plurality of optical fibers includes fifth and sixth groups of optical fibers. The second set of ferrules includes a fourth ferrule and a fifth ferrule. The fourth ferrule supports optical fibers of the first, second, third, and fourth groups of optical fibers, and the fifth ferrule supports optical fibers of the third, fourth, fifth, and sixth groups of optical fibers. Such an assembly may facilitate conversion of three sets of transmit/receive optical pathways into two sets, for conveyance via trunk cables, where an identical assembly is configured to facilitate reversing the conversion on the far end of the trunk cables, without changing the order of individual pathways in the three sets of transmit/receive optical pathways.

Another embodiment relates to a fiber optic system for parallel-optic data transmission, which includes a first conversion module and a second conversion module. The first conversion module has a housing and includes first, second, and third ferrules coupled to a first side of the housing, and fourth and fifth ferrules coupled to a second side of the housing opposite to the first side of the housing. The first conversion module is configured to convert sets of optical fibers supported by the first, second, and third ferrules into sets of optical fibers supported by the fourth and fifth ferrules. The second conversion module identical to the first conversion module, and the first and second conversion modules are interchangeable in the fiber optic system such that (1) when the first and second conversion modules are aligned with one another but rotated 180-degrees relative to one another so that the second sides of the first and second conversion modules face one another and the fourth ferrule of the first conversion module is opposite to the fifth ferrule of the second conversion module, and (2) when trunk cables connect the fourth ferrules of the first and second conversion modules, without flipping fibers, and the fifth ferrules of the first and second conversion modules, without flipping fibers, then optical pathways provided by the optical fibers supported by the first, second, and third ferrules of the first conversion module are connected to and arranged in the same order as optical pathways provided by the optical fibers supported by the first, second, and third ferrules of the second conversion module, respectively. Accordingly, the two conversion modules may be used interchangeably on either side of the trunk cables without additional componentry for reordering of the optical pathways.

Yet another embodiment relates to a ferrule for a fiber optic assembly. The ferrule includes a first group of holes formed therein and a second group of holes formed therein. The holes of the first group are arranged in a line, and each hole of the first group is equally spaced from at least another hole of the first group. Also, the holes of the second group are arranged in a line, and each hole of the second group is equally spaced from at least another hole of the second group. The line formed by the holes of the first group is co-linear with the line formed by the holes of the second group, but the first group of holes are spaced apart from the second group of holes by a portion of the ferrule that is wider than the equal spacing between holes of the holes of either the first or second groups of holes.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 is schematic view a fiber optic conversion module according to an exemplary embodiment.

FIG. 2 is a schematic view of the fiber optic conversion module of FIG. 1 showing optical fiber routing within the module.

FIG. 3 is a perspective view of a module according to an exemplary embodiment.

FIG. 4 is a schematic view of two identical fiber optic conversion modules, as shown in FIG. 1, oriented to operate together in a parallel-optics system according to an exemplary embodiment.

FIG. 5 is a schematic view of the parallel-optics system of FIG. 4 showing optical fiber routing within the system.

FIGS. 6A and 6B are schematic views of a parallel-optics system, similar to the system of FIG. 4, and further including patch cords connecting to electronic hardware according to another exemplary embodiment.

FIG. 7 is a schematic view of a harness cable having a fiber-routing scheme similar to that of the conversion module of FIG. 1 according to an exemplary embodiment.

FIG. 8 is a perspective view of a harness cable according to an exemplary embodiment.

FIG. 9 is a front view of a multi-fiber connector according to an exemplary embodiment.

FIG. 10 is a front view of a multi-fiber connector according to another exemplary embodiment.

### DETAILED DESCRIPTION

Before turning to the following Detailed Description and Figures, which illustrate exemplary embodiments in detail, it should be understood that the present inventive and innovative technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

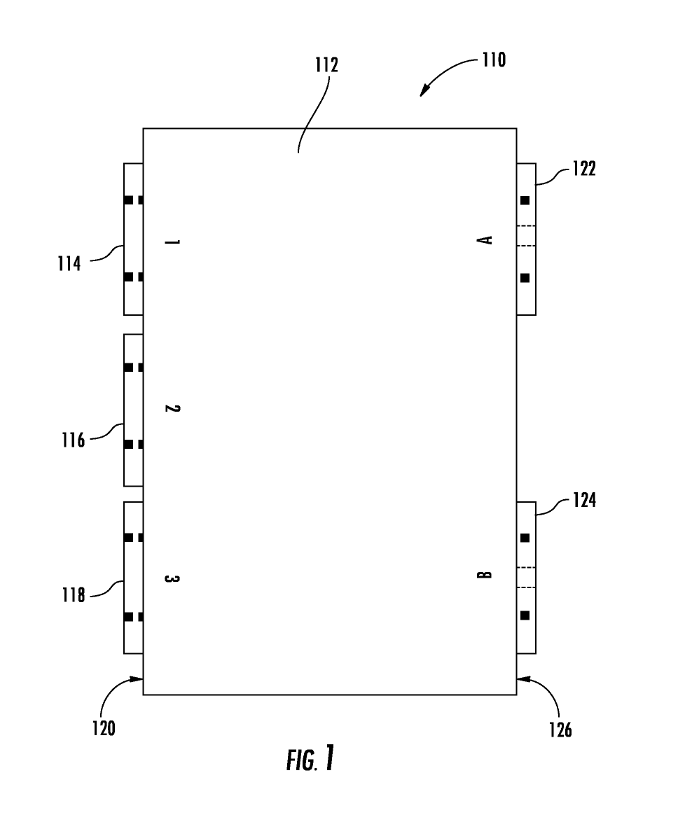

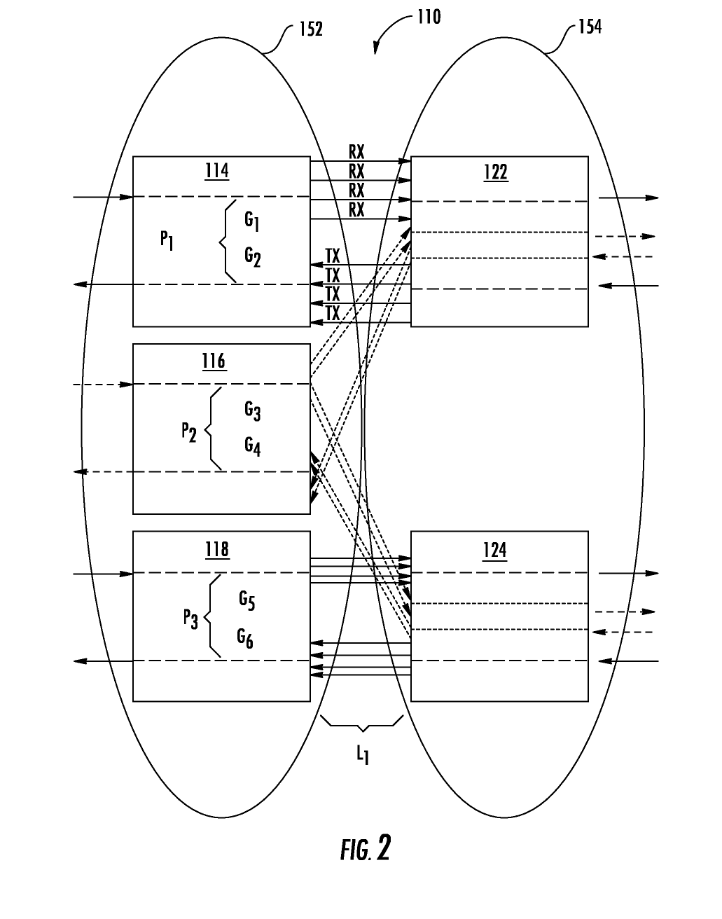

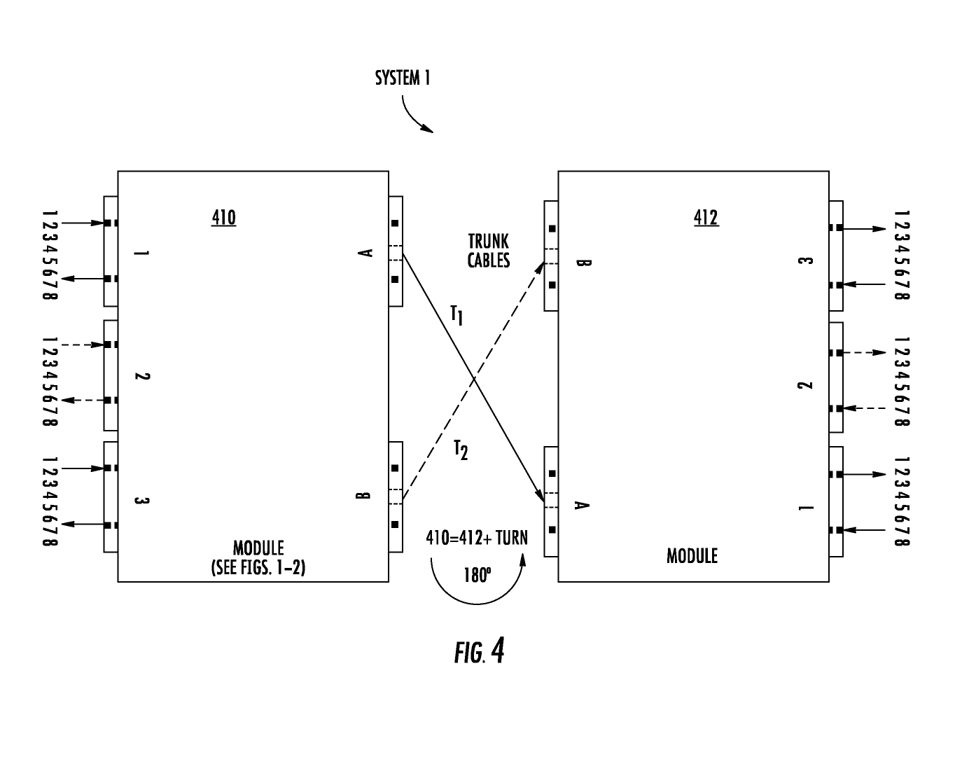

Referring to FIG. 1, a module 110 has a housing 112 and includes first, second, and third ferrules 114, 116, 118 coupled to a first side 120 of the housing 112, and fourth and fifth ferrules 122, 124 coupled to a second side of the housing 126 opposite to the first side of the housing 120. The module 110 is configured to convert sets of optical fibers supported by the first, second, and third ferrules into sets of optical fibers supported by the fourth and fifth ferrules (see FIG. 2). Indicia, such as port number, on the module 110 is accurate regardless of the position of the module on either side of trunk cables in a parallel optics data transmission system (see FIGS. 4-6). FIG. 2 includes the fiber optic routing scheme for optical pathways (within optical fibers or connected optical fibers) within the module 110.

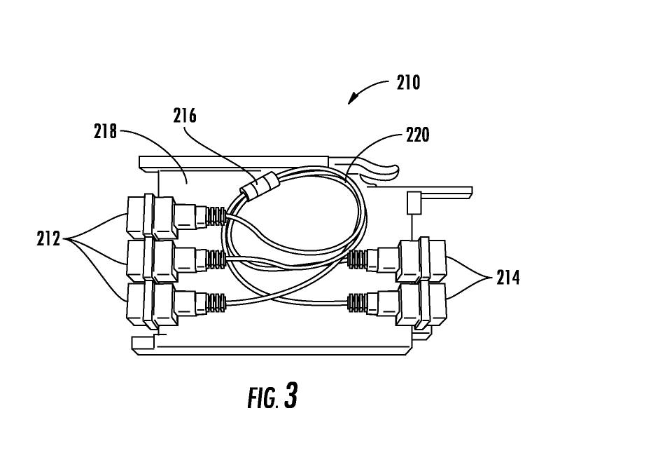

Referring now to FIGS. 2-3, the fiber optic assembly 110 includes first, second, third, fourth, fifth, and sixth groups of optical fibers G₁, G₂, G₃, G₄, G₅, G₆, a first connector set 152, and a second connector set 154. The groups of optical fibers G₁, G₂, G₃, G₄, G₅, G₆ are arranged in data transmission pairs of the groups such that one group of each pair is configured to transmit data and the other group of the pair is configured to receive data (symbolized in FIGS. 2-3 by arrows according to an embodiment). The groups of each pair may be configured to both transmit and/or receive data. According to an exemplary embodiment, the pairs of the groups are organized such that a first pair P₁ includes the first and second groups G₁(e.g., transmit pathways), G₂ (e.g., receive pathways) of optical fibers, a second pair P₂ includes the third and fourth groups G₃ (e.g., transmit pathways), G₄ (e.g., receive pathways) of optical fibers, and a third pair P₃ includes the fifth and sixth groups G₅ (e.g., transmit pathways), G₆ (e.g., receive pathways) of optical fibers.

According to an exemplary embodiment, the first connector set 152 includes first, second, and third ferrules 114, 116, 118 (see FIG. 2; as may be used with interfaces, adapters, multi-fiber connectors), and the second connector set 154 includes fourth and fifth ferrules 122, 124. In some embodiments, the optical fibers of each group G₁, G₂, G₅, G₆ are the same length as the other optical fibers of the respective group G₁, G₂, G₅, G₆ (e.g., less than 1% difference in length relative to the longest fiber). Configuring the optical fibers of a particular group to be the same length as one another is intended to reduce skew in data transmission via parallel-optics processes (see Background).

According to an exemplary embodiment, the first pair P₁ of groups of optical fibers extends between the first and fourth ferrules 114, 122 such that the optical fibers of the first and second groups G₁, G₂ of optical fibers are the same length as one another (e.g., less than 1% difference in average length of the groups' fibers relative to the longer group's average length). The third pair P₃ of groups of optical fibers extends between the third and fifth ferrules 118, 124 such that the optical fibers of the fifth and sixth groups G₅, G₆ of optical fibers are the same length as one another. In some embodiments, the optical fibers of the groups G₁, G₂, G₅, G₆ of optical fibers of the first and third pairs P₁, P₃ are all the same length as one another, but need not always be so.

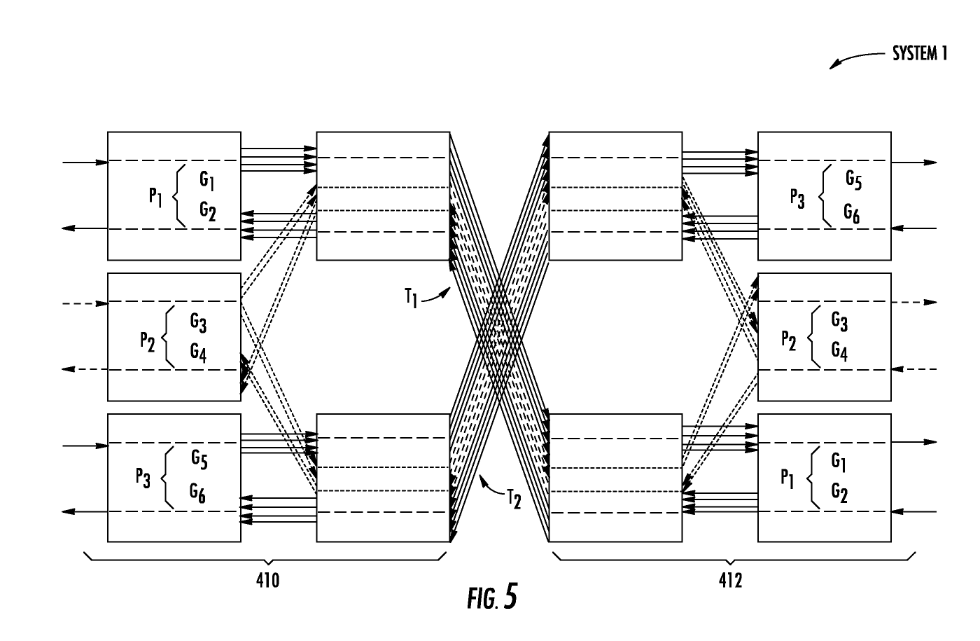

According to an exemplary embodiment, half the third group G₃ of optical fibers extends between the second and fourth ferrules 116, 122 and half the third group G₃ of optical fibers extends between the second and fifth ferrules 116, 124. In some such embodiments, half the fourth group G₄ of optical fibers extends between the second and fifth ferrules 116, 124, and half the fourth group G₄ of optical fibers extends between the second and fourth ferrules 116, 122. In some embodiments, the optical fibers of the third and fourth groups G₃, G₄ of optical fibers are a different length (e.g., at least 1% difference in average length of the groups' fibers relative to the longer group's average length) than the optical fibers of the groups G₁, G₂, G₅, G₆ of optical fibers of the first and third pairs P₁, P₃ (see, e.g., L₁ as shown in FIG. 1 and compare to L₄ as shown in FIG. 5).

According to an exemplary embodiment, the first pair P₁ of groups of optical fibers only extends between the first and fourth ferrules 114, 122, and the third pair P₃ of groups of optical fibers only extends between the third and fifth ferrules 118, 124. Such an arrangement facilitates a direct route of communication between the respective connectors, thereby reducing the path length of optical fibers (and associated attenuation) and reducing the complexity of the scheme relative to more elaborate arrangements. In some embodiments, the optical fibers of the third group G₃ extend between the second and fourth ferrules 116, 122, and between the second and fifth ferrules 116, 124; and the optical fibers of the fourth group G₄ only extend between the second and fifth ferrules 116, 124 and between the second and fourth ferrules 116, 122,.

According to an exemplary embodiment, the first, second, third, fourth, fifth, and sixth groups of optical fibers G₁, G₂, G₃, G₄, G₅, G₆, each include at least two optical fibers per group, such as at least four, at least six, at least eight, at least twelve, at least twenty-four, at least one-hundred-and-forty-four, or more. In some embodiments, the first, second, third, fourth, fifth, and sixth groups of optical fibers G₁, G₂, G₃, G₄, G₅, G₆ each include the same number of optical fibers as one another, such as two per group, such as at least four, at least six, at least eight, at least twelve, at least twenty-four, at least one-hundred-and-forty-four per group, or more. The number of fibers in groups of the same pair may be the same. The number of fibers in groups of optical fibers in all of the groups G₁, G₂, G₃, G₄, G₅, G₆ may be the same, or may differ, such as four fibers in each of groups G₁, G₂, G₅, G₆ and eight fibers in each of groups G₃, G₄. The fibers of a group, of a pair, and/or of the harness assembly may operate in conjunction with one another to provide a finely parsed signal(s) and a correspondingly higher rate of data transmission, when compared to schemes using a fewer number of fibers per group (such as only one single mode fiber). In various alternate embodiments, the optical fibers of the groups may be arranged in different configurations, such as loose optical fibers (single mode or multi-mode), ribbons of optical fibers joined together, or even one or more “multi-core” fibers that include multiple optical fibers bound in a single cladding.

Referring to FIGS. 3 and 7-8, a cable assembly 210, 310 may include a furcation 216, 316 (e.g., partitioning element, separation structure) between the first and second sets of ferrules 312, 314 (see also connectors 212, 214 including ferrules therein) through which passes each of the groups of optical fibers (see also FIG. 2). The cable assembly 210, 310 may have the same optical fiber routing scheme as the module 110 of FIG. 2.

FIG. 3 shows the furcation 216 as part of a harness within a module 210, such as the module 110, which also includes a housing 218 supporting fiber optic cables 220 and multi-fiber connectors 212, 214 arranged in a scheme similar to FIGS. 1-2 or the alternate embodiments disclosed.

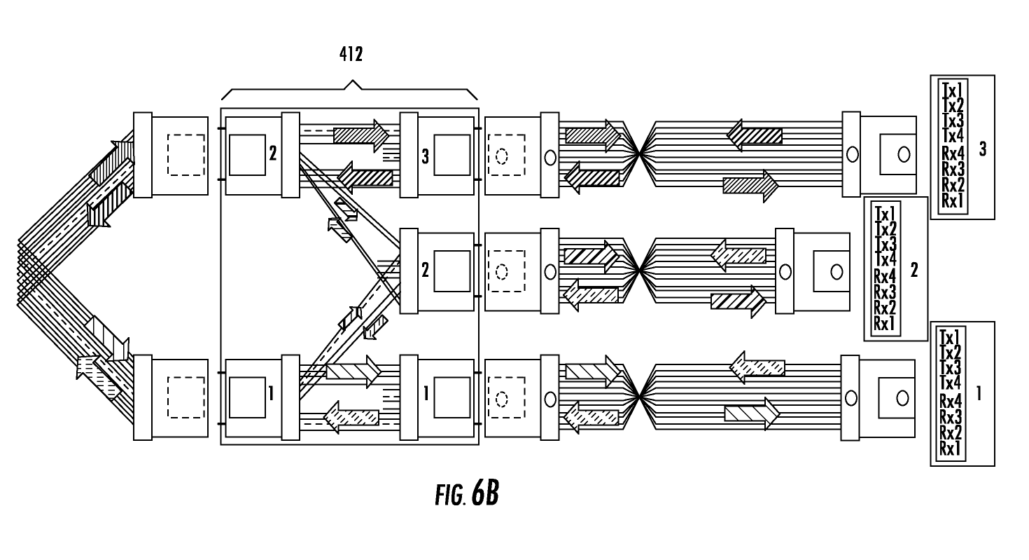

FIG. 7 shows the furcation 316 as part of the harness cable 310. As shown in FIGS. 3-4, there is a separate tube 320 (e.g., jacket, sheath, furcation tube, leg) between the furcation 316 and each of the connectors 312, 314, and each of the groups of optical fibers passes through two of the tubes 320 between the first and second sets of connectors 312, 314.

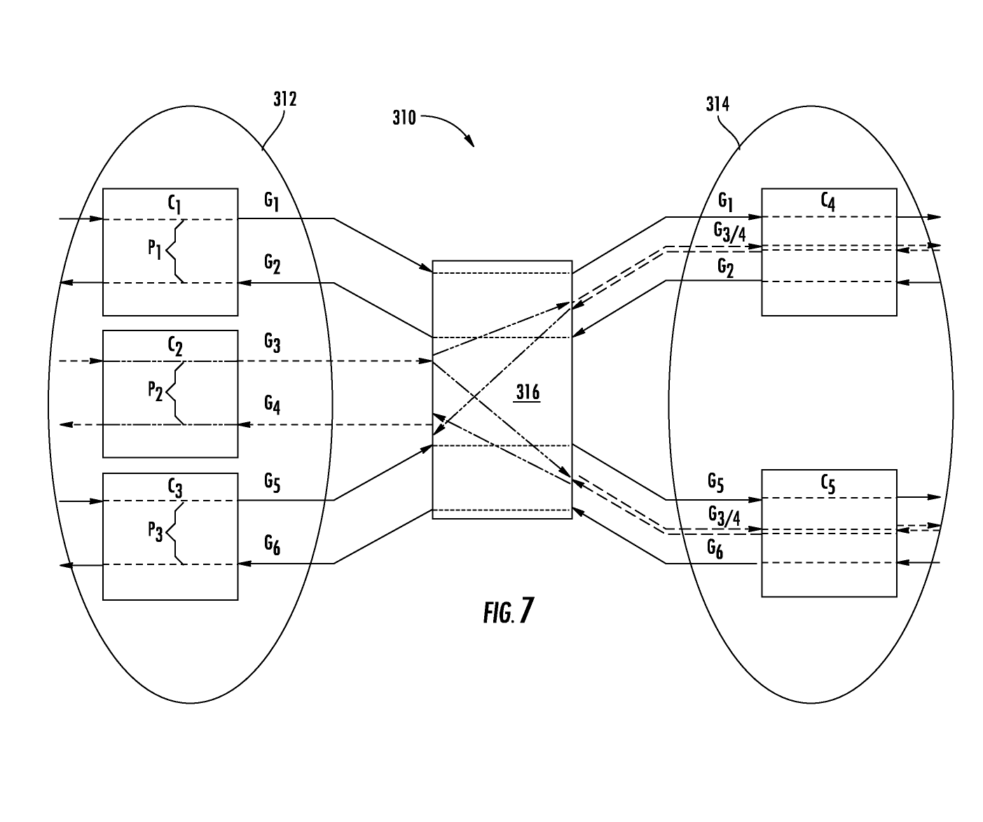

In FIG. 3, the connectors 212, 214 are constrained relative to one another by the housing 218, while in FIG. 8 the tubes 320 are maneuverable and are at least 0.3 m in length, whereby any two of the connectors 312, 314 may be positioned relative to one another anywhere in a distance range between adjoining one another (i.e., touching) to at least 0.5 m apart from one another (i.e., about 0.6 m) (e.g., or at least about 1 m apart from one another where the length of the tubes is at least 0.5 m in length; or greater distances with greater tube lengths), which allows for great flexibility in the routing of data communications, such as between various components of computer hardware in a data center. In contemplated embodiments, the tubes 320 are at least 0.2 m in length, but less than 0.3 m in length, such as about 0.24 m for tubes 320 within a module.

Referring to FIG. 3, Applicants have found that the maximum length of the harness cables 220 within the module 210 should be approximately twelve and a half inches (or the metric equivalent length), which has been found to allow enough slack for the cables 220 to be inside the module space (i.e., within the housing 218) without going under the connectors 212, 214. The minimum length of the harness cables 220 should be approximately nine and a half inches, which will allow for two reworks of the connectors 212, 214 at 38 mm length, as necessary, and still allows enough slack in the module 210 for low tension on the fibers in the cables 220.

Referring to FIG. 4, two cable assemblies 410, 412 (see also FIGS. 1-2), modules and/or cables as disclosed herein, may be used together as part of a polarity scheme and convey data via parallel optics transmission. The assemblies 410, 412 may be joined by trunk cables T₁, T₂, and may be configured according to a standard key-up/key-down configuration, as described in TIA 568C.0 standards (e.g., type A, type B, types A and/or B, type C) with regard to flipping polarity. The trunk cables T₁, T₂ may include any number of trunks or extender trunks, and may be routed through intermediate elements according to a more-elaborate scheme.

As illustrated by the arrows shown in FIG. 5, for example, the trunk cables T₁, T₂ may support optical signals passing in both directions (e.g., both receiving and transmitting groups). This “two-way traffic” in each connector provides robustness to the system, where if one of the two trunk cables T₁, T₂ should fail, the other will still be able to pass signals for data communication, albeit at a slower speed (i.e., data rate).

Parallel optics for four-parallel-lane transmission (Tx) for land receivers (Rx) from 40 G (4×10 G) or 100 G (4×25 G) utilizing a twelve-fiber base multi-fiber connector MTP structure, as specified in IEEE (4×10), utilizes only 8-fibers out of the twelve-fiber MTP. However, embodiments disclosed herein enable customers to utilize all 12-fiber in backbone trunks, when six groups include four fibers each (see FIGS. 1-2). Additionally, the disclosed polarity schemes for QSFP devices (see FIG. 5) keep a logical flow of MTPs on one side to go to the nearest other MTP; the middle MTP is the only one that is split. In furcation during manufacturing, the process may be kept simple by utilizing two subunits and keeping most of the fibers grouped in the same tube. Only fibers from the middle MTP (e.g., pair P₂ as shown in FIGS. 1-2) are diverted in groups. While other schemes may mix fibers from several groups, which increases risks of improper polarity. Furthermore, embodiments disclosed herein reduce skew because at least some parallel signals are kept along the same path with the same length.

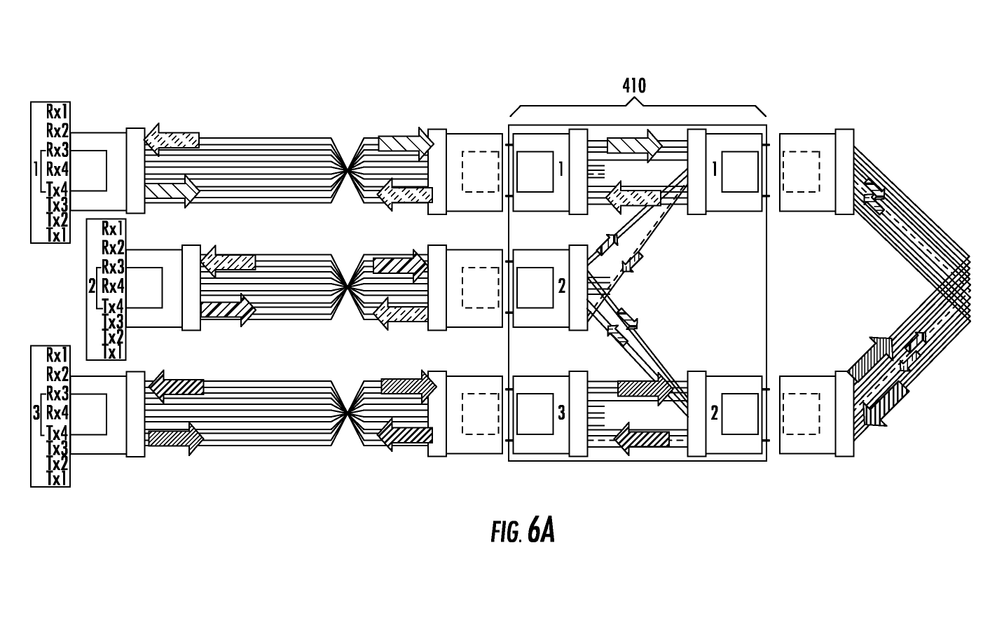

When converting to parallel optic systems, customers may face difficulty managing the placement of alignment pins in a fiber optic link, which are typically required for MTP/MPO connector mating, where one connector is pinned and the other pin-less. In addition, SR4 transmission requires 8-fibers for communication, however most current MPO cabling systems are 12-fiber or 24-fiber based, which results in less than 100% fiber utilization. See generally the patch cords shown in FIG. 6A-6B.

According to another aspect of technology disclosed herein, a user is able to use a single jumper to install at any location in a link and with any orientation regardless of system architectures by using a pin-less jumper (i.e., no pins on associated connectors) to plug into both the electronics and patch field. Some such embodiments include a pinned-to-pinned conversion module that allows a single pin-less jumper to be utilized in all system architectures while achieving 100% fiber utilization. According to an exemplary embodiment, the conversion could be any variation of the following configurations in addition to their multiples: (1) 24-fiber MPO to (3) 8-fiber MPO; (2) 12-fiber MPO to (3) 8-fiber MPO; (1) 24-fiber MPO to (2) 12-fiber MPO; (1) 48-fiber MTP to (6) 8-fiber MPO or (2) 24-fiber. In some embodiments, MTP jumpers are converted or replaced from a pinned-unpinned structure jumper, to a completely pin-less jumper structure. In addition, this same pin-less jumper may work in a direct-connect (from electronic port to electronic port) and in a cross-connect cabling scheme. By contrast, with contemporary systems such cabling schemes would require various wiring/pinning jumper schemes, but the present solution simplifies the options for a single jumper solution to “fit all.” Combining such a structure with a pinned MTP connector inside a module (see, e.g., FIG. 3) allows all trunks and jumpers in the link to be of the same polarity and pinning Referring to FIG. 3, a conversion device could be in a Plug & P1ay™ closet connector housing (CCH) module footprint or a Pretium EDGE® module footprint, as manufactured by Corning Cable Systems LLP of Hickory, N.C., United States of America. Some embodiments include pinned MTP connectors inside the module with unpinned trunks/jumpers external to the module.

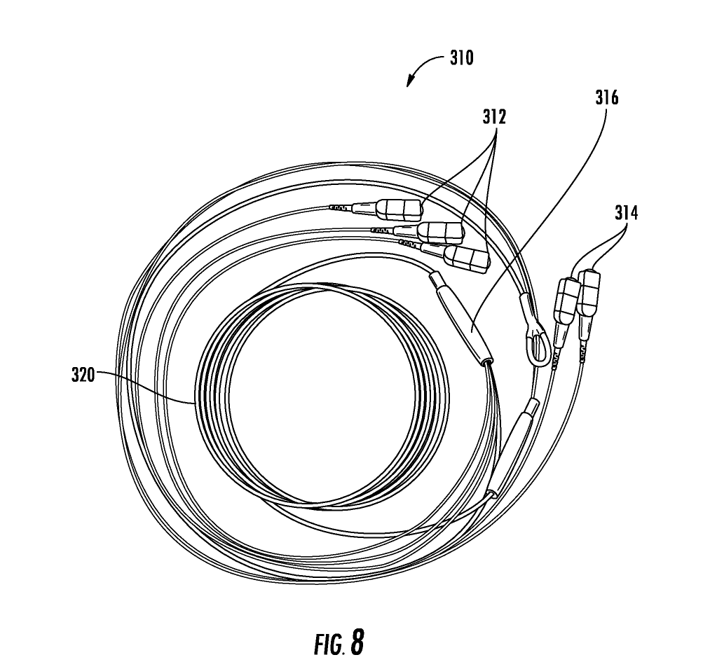

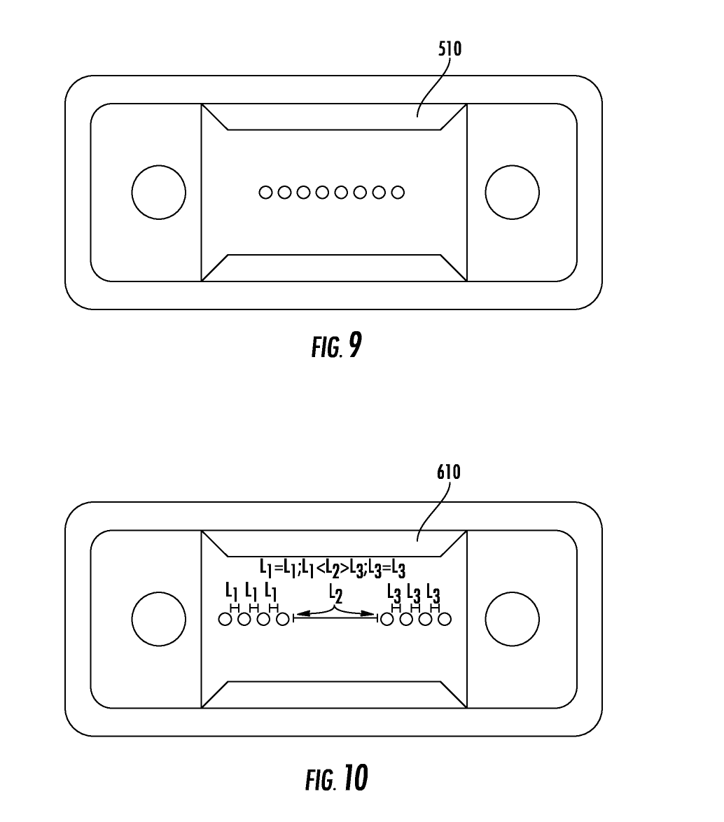

Referring to FIGS. 9-10, for parallel optics data transmission, modules and harness cables are typically set up connectors configured for the same number of optical fibers, regardless of whether the optical fibers are active in the system. For example, a 40 G system may use three twelve-fiber connectors on one side of a module and two twelve-fiber connectors on the opposite side of the module. On the three-connector side, the twelve-fiber connectors only carry eight active optical pathways. The other four fibers are “dead” or inactive (i.e., the other four pathways are inactive). As such, the three twelve-fiber connectors may be a source for error when optically connecting thereto, because an operator may inadvertently attach a live optical pathway to a “dead” channel or vice versa. However, eight-fiber connectors may not conform to industry-wide specifications or standards, such as IEEE standards.

The ferrules shown in FIGS. 9-10 are eight-fiber connectors , where the eight holes in the connectors are located in the place of the active pathways of a twelve fiber connector. For the ferrule 510 of FIG. 9, two holes are not present on either side of the group. For the ferrule 610 of FIG. 10, four holes are not present in the center of the ferrule, between first and second groups.

In FIG. 10, spacing L₁ between each of the holes on the left is equal, and spacing L₃ between each of the holes on the right is equal, but the spacing L₂ between the left and right groups is greater than the spacing L₁, L₃ between the holes of either group. The holes of each group may be aligned, and lines formed by the two groups of holes may be aligned with one another.

As shown, in FIG. 10, for example, the fiber holes have 0.250 mm pitch (which is standard for twelve-fiber MPO connectors), but the center holes are not present. As such, the ferrule includes twelve-fiber spacing for eight holes, with the hole spacing from first hole (reference as 0.000) in (mm) being: 0.000, 0.250, 0.500, 0.750, 2.000, 2.250, 2.500, 2.750. The holes typically at 1.000, 1.250, 1.500, and 1.750 are not present. As such, for a typical eight-fiber connector, the holes may be too close together. But the removal of four holes reduces the chance of assembly error.

The construction and arrangements of the fiber optic harness assembly and polarity schemes, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive and innovative technology.

What is claimed is:

1. A fiber optic assembly, comprising:
a first set of ferrules, comprising:
a first ferrule supporting a first plurality of optical fibers, wherein the first plurality of optical fibers comprises first and second groups of optical fibers;
a second ferrule supporting a second plurality of optical fibers, wherein the second plurality of optical fibers comprises third and fourth groups of optical fibers; and
a third ferrule supporting a third plurality of optical fibers, wherein the third plurality of optical fibers comprises fifth and sixth groups of optical fibers;
a second set of ferrules, comprising;
a fourth ferrule supporting optical fibers of the first, second, third, and fourth groups of optical fibers; and
a fifth ferrule supporting optical fibers of the third, fourth, fifth, and sixth groups of optical fibers.

2. The fiber optic assembly of claim 1, wherein the optical fibers of the first group, as supported by the first ferrule, are aligned side-by-side with one another in a row;
wherein the optical fibers of the second group, as supported by the first ferrule, are aligned side-by-side with one another in a row;
wherein the optical fibers of the third group, as supported by the second ferrule, are aligned side-by-side with one another in a row;
wherein the optical fibers of the fourth group, as supported by the second ferrule, are aligned side-by-side with one another in a row;
wherein the optical fibers of the fifth group, as supported by the third ferrule, are aligned side-by-side with one another in a row; and
wherein the optical fibers of the sixth group, as supported by the third ferrule, are aligned side-by-side with one another in a row.

3. The fiber optic assembly of claim 2, wherein the optical fibers of the first group, as supported by the fourth ferrule, are aligned side-by-side with one another in a row;
wherein the optical fibers of the second group, as supported by the fourth ferrule, are aligned side-by-side with one another in a row;
wherein the optical fibers of the fifth group, as supported by the fifth ferrule, are aligned side-by-side with one another in a row; and
wherein the optical fibers of the sixth group, as supported by the fifth ferrule, are aligned side-by-side with one another in a row.

4. The fiber optic assembly of claim 3, wherein all of the optical fibers of the first and second groups are supported by the first and fourth ferrules; and
wherein all of the optical fibers of the fifth and sixth groups are supported by the third ferrule and the fifth ferrule.

5. The fiber optic assembly of claim 4, wherein half the optical fibers of the third group are supported by the fourth ferrule and half the optical fibers of the third group are supported by the fifth ferrule; and
wherein half the optical fibers of the fourth group are supported by the fourth ferrule and half the optical fibers of the fourth group are supported by the fifth ferrule.

6. The fiber optic assembly of claim 5, wherein each of the first, second, third, fourth, fifth, and sixth groups of optical fibers comprises two optical fibers.

7. The fiber optic assembly of claim 6, wherein each of the first, second, third, fourth, fifth, and sixth groups of optical fibers comprises four optical fibers.

8. The fiber optic assembly of claim 7, wherein each of the first, second, third, fourth, fifth, and sixth groups of optical fibers comprises ten optical fibers.

9. The fiber optic assembly of claim 7, wherein the first, second, third, fourth, fifth, and sixth groups of optical fibers each include the same number of optical fibers as one another.

10. The fiber optic assembly of claim 7, wherein the optical fibers of the first group are all essentially the same length as one another such that skew of optical communications transmitted in parallel through the optical fibers of the first group between the first and fourth ferrules is less than 500 picoseconds.

11. The fiber optic assembly of claim 10, wherein the optical fibers of the first and second groups are all essentially the same length as one another such that skew of optical communications transmitted in parallel through the optical fibers of the first and second groups between the first and fourth ferrules is less than 500 picoseconds.

12. The fiber optic assembly of claim 11, further comprising a housing, wherein the first, second, and third ferrules are coupled to a first side of the housing and the fourth and fifth ferrules are coupled to a second side of the housing, and wherein the first and second sides of the housing are opposite to one another.

13. The fiber optic assembly of claim 11, further comprising at least one furcation between the first and second sets of connectors through which passes each of the groups of optical fibers.

14. The fiber optic assembly of claim 13, further comprising a separate tube between the at least one furcation and each of the connectors, and wherein each of the groups of optical fibers passes through two of the tubes.

15. The fiber optic assembly of claim 14, wherein the tubes are maneuverable and are at least 0.3 m in length, whereby any two of the connectors may be positioned relative to one another anywhere in a distance range between adjoining one another to at least 0.5 m apart from one another.

16. A fiber optic system for parallel-optic data transmission, comprising:
a first conversion module having a housing and comprising:
first, second, and third ferrules coupled to a first side of the housing; and
fourth and fifth ferrules coupled to a second side of the housing opposite to the first side of the housing,
wherein the first conversion module is configured to convert sets of optical fibers supported by the first, second, and third ferrules into sets of optical fibers supported by the fourth and fifth ferrules;
a second conversion module identical to the first conversion module,
wherein the first and second conversion modules are interchangeable in the fiber optic system such that:
when the first and second conversion modules are aligned with one another but rotated 180-degrees relative to one another so that the second sides of the first and second conversion modules face one another and the fourth ferrule of the first conversion module is opposite to the fifth ferrule of the second conversion module, and
when trunk cables connect the fourth ferrules of the first and second conversion modules, without flipping fibers, and the fifth ferrules of the first and second conversion modules, without flipping fibers,
then optical pathways provided by the optical fibers supported by the first, second, and third ferrules of the first conversion module are connected to and arranged in the same order as optical pathways provided by the optical fibers supported by the first, second, and third ferrules of the second conversion module, respectively, whereby the two conversion modules may be used interchangeably on either side of the trunk cables without additional componentry for reordering of the optical pathways.

17. The fiber optic system of claim 16, wherein the first ferrule supports a first plurality of optical fibers, wherein the first plurality of optical fibers comprises first and second groups of optical fibers;
wherein the second ferrule supports a second plurality of optical fibers, wherein the second plurality of optical fibers comprises third and fourth groups of optical fibers;
wherein the third ferrule supports a third plurality of optical fibers, wherein the third plurality of optical fibers comprises fifth and sixth groups of optical fibers;
wherein the fourth ferrule supports the optical fibers of the first, second, third, and fourth groups of optical fibers;
wherein the fifth ferrule supports the optical fibers of the third, fourth, fifth, and sixth groups of optical fibers;
wherein the optical fibers are of the first group, as supported by the first ferrule, are aligned side-by-side with one another in a row;
wherein the optical fibers of the second group, as supported by the first ferrule, are aligned side-by-side with one another in a row;
wherein the optical fibers of the third group, as supported by the second ferrule, are aligned side-by-side with one another in a row;
wherein the optical fibers of the fourth group, as supported by the second ferrule, are aligned side-by-side with one another in a row;
wherein the optical fibers of the fifth group, as supported by the third ferrule, are aligned side-by-side with one another in a row;
wherein the optical fibers of the sixth group, as supported by the third ferrule, are aligned side-by-side with one another in a row;
wherein all of the optical fibers of the first and second groups are supported by the first and fourth ferrules;
wherein all of the optical fibers of the fifth and sixth groups are supported by the third ferrule and the fifth ferrule;
wherein half the optical fibers of the third group are supported by the fourth ferrule and half the optical fibers of the third group are supported by the fifth ferrule;
wherein half the optical fibers of the fourth group are supported by the fourth ferrule and half the optical fibers of the fourth group are supported by the fifth ferrule;
wherein each of the first, second, third, fourth, fifth, and sixth groups of optical fibers comprises four optical fibers; and
wherein the first, second, third, fourth, fifth, and sixth groups of optical fibers each include the same number of optical fibers as one another.

18. The fiber optic system of claim 16, further comprising the trunk cables.
